(19) United States
(12) Patent Application Publication
(10) Pub. No.: US 2012/0146346 A1
(43) Pub. Date: Jun. 14, 2012

(54) SYSTEM AND METHOD FOR GANGING LOCKS

(76) Inventors: Bruce Hagemeyer, Pella, IA (US); Dan Raap, Hartford, SD (US); Gary E. Tagtow, Sioux Falls, SD (US)

(21) Appl. No.: 13/315,715

(22) Filed: Dec. 9, 2011

Related U.S. Application Data
(60) Provisional application No. 61/422,867, filed on Dec. 14, 2010.

(51) Int. Cl. E05C 3/16; B23P 11/00; G05G 1/00

(52) U.S. Cl. 292/217; 74/519; 29/428

(57) ABSTRACT

A multi-point door lock includes first and second lock assemblies. Each assembly includes a housing, an actuator defining an actuator slot, and a locking element pivotally engaged with the housing, wherein a rotation of the actuator causes a rotation of the locking element from a retracted position to an extended position. A master lever arm is located external from the first lock assembly housing and defines a master lever arm slot aligned with the actuator slot of the first lock assembly. A slave lever arm is located external from the second lock assembly housing and is engaged with the actuator slot of the second lock assembly. A link connects both the master lever arm and the slave lever arm and is located external to both the first lock assembly housing and the second lock assembly housing. A face plate is secured to each lock assembly housing.

### CROSS REFERENCE TO RELATED APPLICATIONS

This application claims priority to and the benefit of U.S. Provisional Application Ser. No. 61/422,867, filed Dec. 14, 2010, entitled “System and Method for Ganging Locks,” the disclosure of which is hereby incorporated by reference herein in its entirety.

### INTRODUCTION

Multi-point locks are often used on sliding doors. The locks may include two or more locking elements that pivot out of one or more lock housings to engage with keeper elements on a door frame. Multi-point locks offer increased security over single-point locks that include only a single locking element. Some advantages of multi-point locks include locking elements that pivot in opposite directions, to both upwardly engage and downwardly engage an associated keeper. This engagement in two directions helps prevent a sliding door from being lifted off a track, which may defeat the lock. Additionally, since the locking elements of multi-point locks may be located a distance from a central location (typically sliding door locks are installed near a handle of a door), it may be more difficult for a would-be intruder to identify the locking element locations, thus reducing the intruder's ability to overcome the lock. Other advantages of multi-point locks are known in the art.

While often more secure, multi-point locks are typically more expensive to manufacture. Such locks often require complex components regardless of the number of lock assemblies used. For locks that include multiple lock assemblies, these assemblies may need to be modified significantly to join a number of assemblies together. In this regard, multi-point locks typically require assembly at a manufacturing facility, which again increases price.

### SUMMARY

In one aspect, the technology relates to a multi-point door lock including: a first lock assembly and a second lock assembly, each of the first lock assembly and the second lock assembly having: a housing; an actuator defining an actuator slot; and a locking element pivotally engaged with the housing, wherein a rotation of the actuator causes a rotation of the locking element from a retracted position to an extended position; a master lever arm located external from the first lock assembly housing and defining a master lever arm slot aligned with the actuator slot of the first lock assembly; a slave lever arm located external from the second lock assembly housing and engaged with the actuator slot of the second lock assembly; a link connected to both the master lever arm and the slave lever arm and located external to both the first lock assembly housing and the second lock assembly housing; and a face plate secured to both the first lock assembly housing and the second lock assembly housing. In one embodiment, the lock includes an actuation lever having a tailpiece engaged with both the master lever arm slot and the actuator slot of the first lock assembly, wherein a rotational force applied by the actuation lever to the master lever arm causes a rotation of the slave lever arm. In another embodiment, the tailpiece is integral with the actuation lever. In yet another embodiment, the slave lever arm includes a projection. In still another embodiment, the locking element of the first lock assembly and the locking element of the second lock assembly rotate in opposite directions.

In another embodiment of the above aspect, the link includes at least one of a bar drive and a cable drive. In another embodiment, the cable drive includes at least one of a channel and a tube, and a cable adapted to move therein. In an embodiment, the cable drive includes a first cable and a second cable, wherein the first cable is connected to a first connection on the master lever arm and the second cable is connected to a second connection on the master lever arm. In yet another embodiment, the first connection, the master lever arm slot, and the second connection define an alignment axis. In still another embodiment, the bar drive is pivotally connected to both of the master lever arm and the slave lever arm.

In another embodiment of the above aspect, the technology relates to a multi-point lock, further including: a third lock assembly having: a third lock assembly housing secured to the face plate; a third lock assembly actuator defining a third lock assembly actuator slot; and a third lock assembly locking element pivotally engaged with the third lock assembly housing; and a third lever arm located external from the third lock assembly housing and having a projection engaged with the third lock assembly actuator slot, wherein the third lever arm is connected to the link.

In another aspect, the technology relates to a gang kit useful in forming a multi-point lock, the gang kit including: a master lever arm defining a master lever arm slot adapted to align with an actuator slot on a first lock assembly; a slave lever arm adapted to engage with an actuator slot on a second lock assembly; a link adapted to connect to both the master lever arm and the slave lever arm; and a face plate adapted to be secured to both the first lock assembly and the second lock assembly. In an embodiment, the gang kit further includes an actuation lever including a tailpiece adapted to engage with both the master lever arm slot and the actuator slot of the first lock assembly. In another embodiment, the gang kit further includes the first lock assembly and the second lock assembly. In yet another embodiment, the gang kit further includes a channel adapted to at least partially enclose the master lever arm, the slave lever arm, and the link. In still another embodiment the channel is integral with the face plate. In another embodiment, the slave link arm includes a projection.

In another aspect, the technology relates to a method of ganging a first lock assembly and a second lock assembly, the method including: securing the first lock assembly and the second lock assembly to a face plate; connecting a link to a master lever arm and a slave lever arm; aligning a slot defined by the master lever arm with an actuator slot of the first lock assembly; and securing a slave lever arm to an actuator of the second lock assembly. In an embodiment, the slave arm securing step includes inserting a projection through both a slave lever arm slot and a slot defined by the actuator of the second lock assembly. In another embodiment, the slave lever arm securing step includes inserting a projection integral with the slave lever arm into a slot defined by the actuator of the second lock assembly. In yet another embodiment, the method includes inserting a tailpiece of an actuation lever through both the master lever arm slot and the actuator slot of the first lock assembly.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1A is an exploded perspective view of a multi-point lock.

FIG. 1B is a side view of the multi-point lock of FIG. 1A having locking elements in a retracted position.

FIG. 1C is a side view of the multi-point lock of FIG. 1A having locking elements in an extended position.

FIG. 2A is a side view of another multi-point lock having locking elements in a retracted position.

FIG. 2B is a side view of the multi-point lock of FIG. 2A having locking elements in an extended position.

FIG. 3 is a side view of another multi-point lock having locking elements in a retracted position.

FIG. 4A is a perspective view of another multi-point lock having locking elements in an extended position.

FIG. 4B is a partial side view of the multi-point lock of FIG. 4A having locking elements in a retracted position.

FIG. 4C is a partial side view of the multi-point lock of FIG. 4A having locking elements in an extended position.

FIG. 5 depicts a method of assembling a multi-point lock.

### DETAILED DESCRIPTION

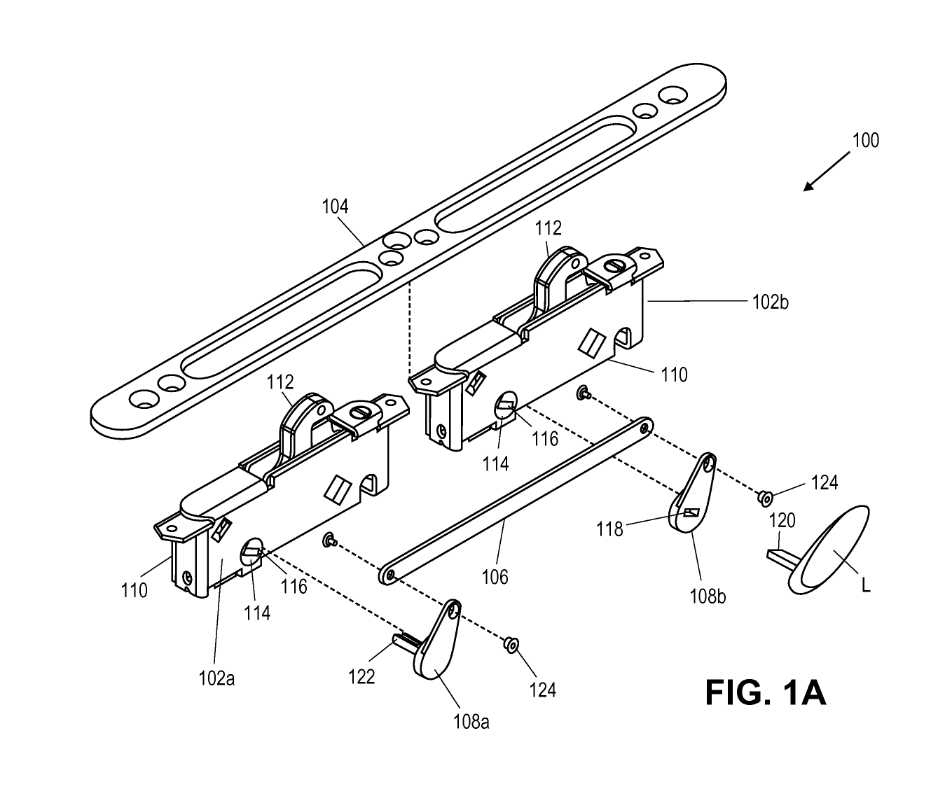

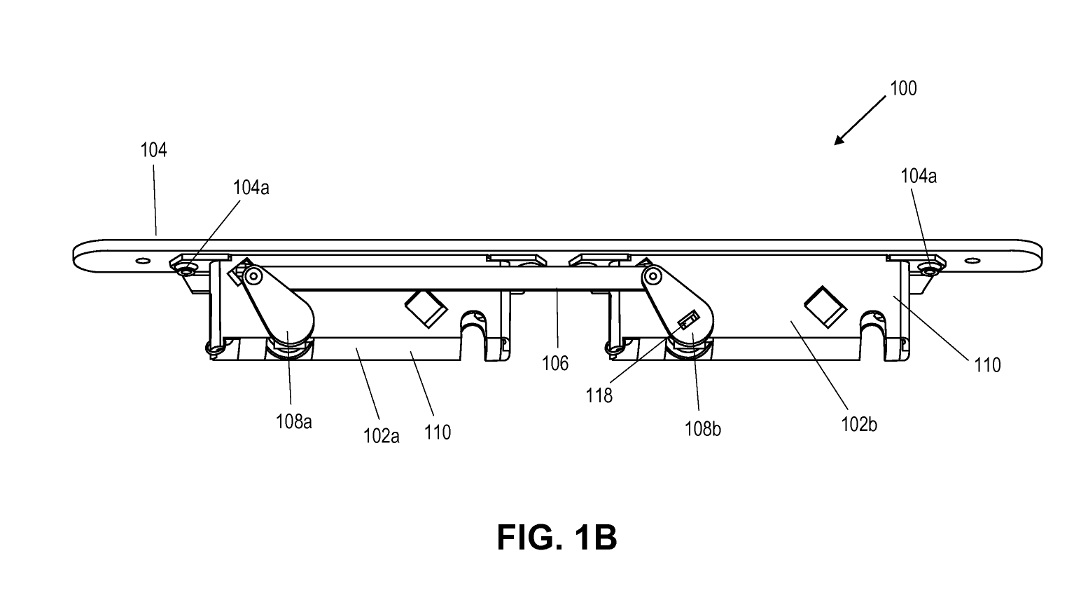

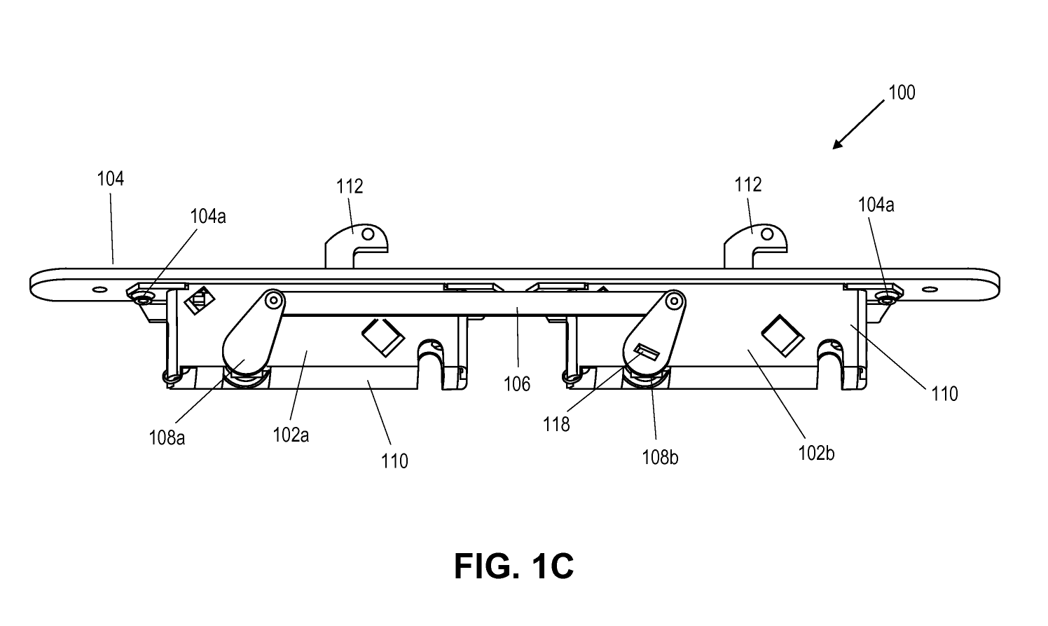

FIGS. 1A-1C depict one embodiment of a multi-point lock (MPL) 100. A typical application for the locks depicted and described herein is for securing sliding glass doors. A person of skill in the art will recognize, however, the many applications that may be appropriate for the depicted locks. The multi-point locks depicted herein may be used for patio, entry, locker, or other doors, as well as pivoting or sliding windows. Regardless, for clarity, a sliding door lock application will be described below.

The MPL 100 depicted in FIGS. 1A-1C includes two lock assemblies 102a, 102b, a face plate 104, a link 106, a master lever arm 108b, and a slave lever arm 108a. The two lock assemblies 102a, 102b, may be the 537 series lock, sold by Amesbury Group, Inc.—Door Hardware Division, of Sioux Falls, S. Dak. An exemplary lock assembly 102a, 102b includes a housing 110 and a locking element 112 pivotally connected thereto. An actuator 114 is engaged with the locking element 112 and includes an actuator slot 116. Other lock assemblies may also be utilized, for example, the two-point assembly described in U.S. Pat. No. 7,418,845, the disclosure of which is hereby incorporated by reference herein in its entirety. The two lock assemblies 102a, 102b are secured or otherwise fixed to the face plate 104. In the depicted embodiment, screws 104a may be used for securement, but other mechanical or chemical fasters may be used. The master lever arm 108b is secured to the actuator 114 within the lock assembly 102b as described below. Pivotal or rotational movement of the actuator 114 moves the locking element 112 in the housing 102a, 102b from the retracted position to the extended position. The master lever arm 108b includes a slot 118 that is configured to align with the slot 116 located within the actuator 114. Both slots 118, 116 are sized and configured to receive a tailpiece 120 from a lock cylinder or actuation lever L. Accordingly, when the tailpiece 120 rotates, it rotates or pivots both the master lever arm 108b and the actuator 114 in the first lock assembly 102b.

A slave lever arm 108a is engaged with an actuator slot 116 on the actuator 114 in the second lock assembly 102a. In the depicted embodiment, a projection 122 is integral with the slave lever arm 108a and engages the actuator slot 116 in the second lock assembly 102a. Additionally or alternatively, either or both of the master lever arm 108b and slave lever arm 108a may be secured to their respective actuators 114 with one or more screws or other fasteners. The link 106 is pivotally connected to both the master lever arm 108b and the slave lever arm 108a with rivets, screws, or other fasteners 124. In another embodiment, the link may define one or more openings sized to engage a projection on each lever arm. This link 106 may be a metal bar or rod, or a free or contained cable or wire. During use, when the lock cylinder or actuation lever L is actuated, the rotation of the tailpiece 120 rotates both the master lever arm 108b and the actuator 114 of the first lock assembly 102b. Rotation of the master lever arm 108b and translation of the link 106 compels rotation of the slave lever arm 108a and, accordingly, the actuator 114 of the second lock assembly 102a. In that regard, rotation of the single lock cylinder or actuation lever L pivots both locking elements 112 from refracted positions to extended positions.

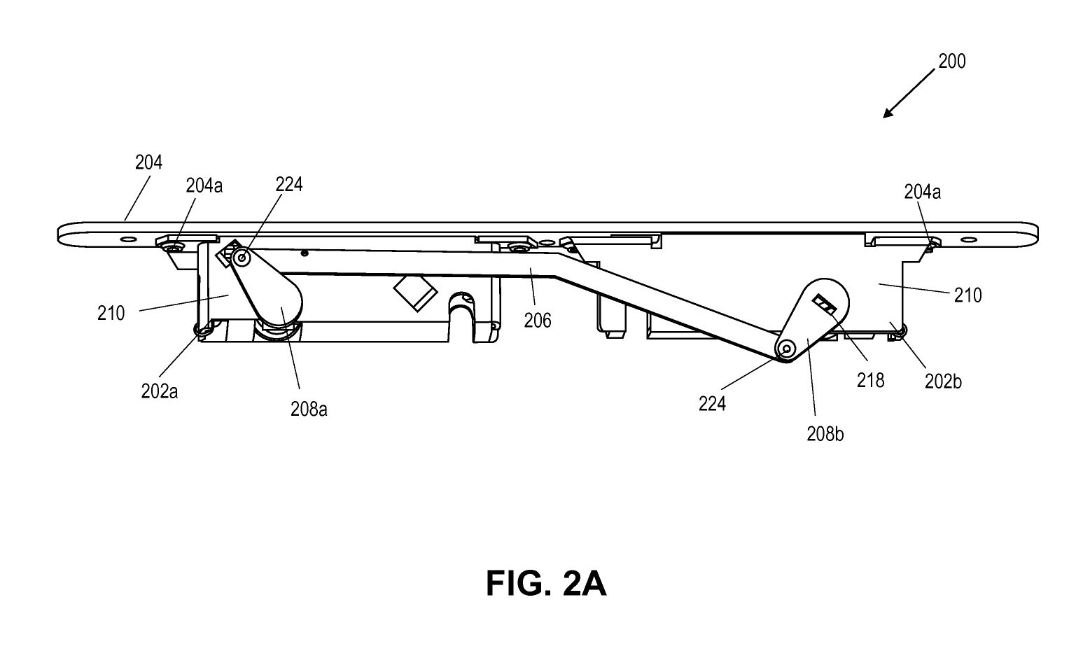

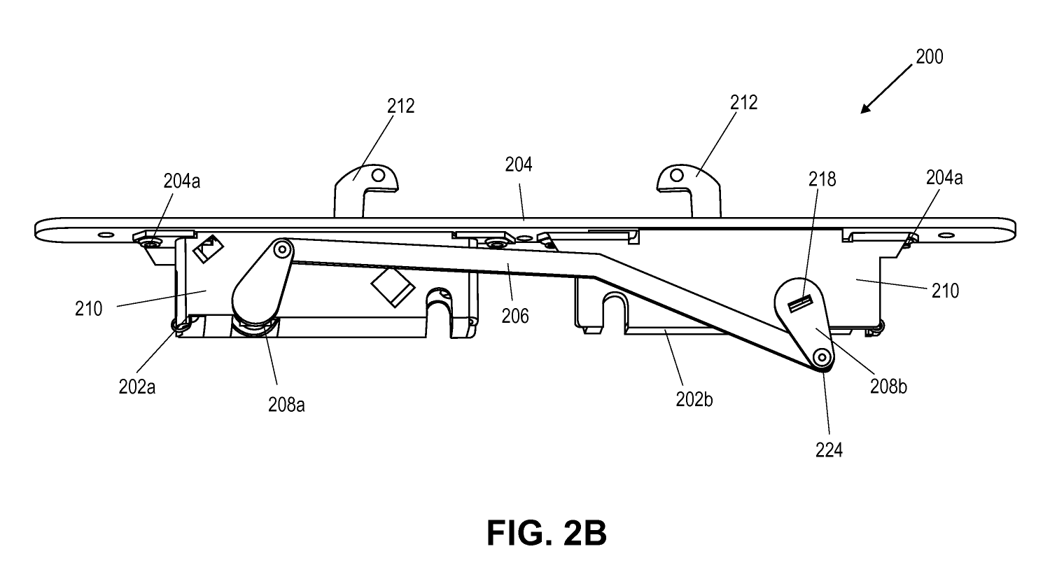

FIGS. 2A-2B depict another embodiment of an MPL 200. The components and operation of the MPL 200 depicted in FIGS. 2A-2B are substantially similar to those of FIGS. 1A-1C. It should be noted, however, that the first lock assembly 202b is installed in a reverse configuration from the second lock assembly 202a. In this case, the locking element 212 of the first lock assembly 202b will pivot or rotate in the opposite direction from the locking element 212 of the second lock assembly 202a. In this case, the link 206 is configured such that a counterclockwise rotation of the master lever arm 208b will cause a corresponding clockwise rotation of the slave lever arm 208a. It should be apparent that in all embodiments the terms “master,” “slave,” “first,” “second,” etc., are used for reference purposes. In various embodiments, the terms may be used interchangeably. For example, the master lever arm may be associated with the actuator in the second lock assembly.

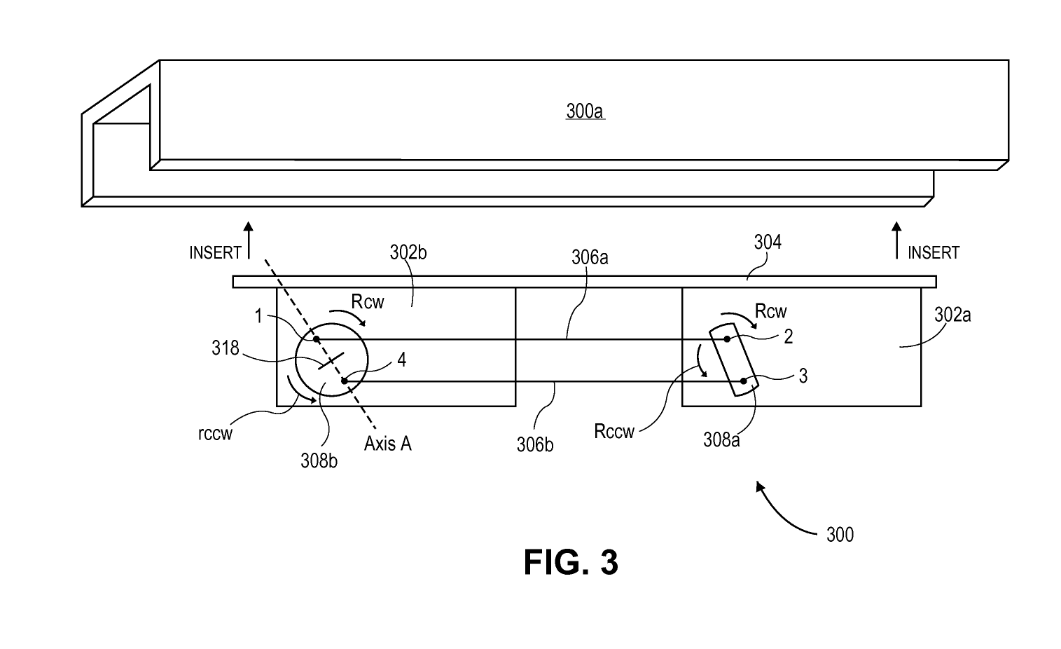

FIG. 3 depicts a side view of another MPL 300. The components and operation of the MPL 300 depicted in FIG. 3 are substantially similar to those of FIGS. 1A-1C. The link depicted in FIG. 3, however, includes two cables 306a, 306b fixed to each of the master lever arm 308b (in this case, in a round configuration) and the slave lever arm 308a (configured in an elongate configuration). Alternatively, a single cable may be fixed to both lever arms. During a clockwise rotation R_{cw} of the master lever arm, cable 306b is tensioned so as to rotate the slave lever arm 308a in a clockwise rotation, thus extending the locking elements into the extended position. Conversely, during a counter-clockwise rotation R_{ccw} of the master lever arm 308b, cable 306a is tensioned so as to rotate the slave lever arm 308a in a counter-clockwise rotation, thus retracting the locking elements. Of course, depending on configuration of the locking element or lock assemblies, counter-clockwise rotation may cause extension of the locking elements, and clockwise rotation may cause retraction.

In an alternative embodiment, cable 306a may instead be connected to points 1 and 3 on the master lever arm 308b, and cable 306b may be connected to points 2 and 4 on the slave lever arm 308a. Provided that one of the lock assemblies 302b, 302a is oriented appropriately, the locking elements of the two assemblies 302b, 302a will extend and retract in opposite pivotal directions. Although points 1 and 4 are depicted aligned along an axis A (sharing the axis A with a point on the slot 318), the connection points between the cables 306a, 306b and the master lever arm 308b (as well as the connection points on the slave lever arm 308a) may be located elsewhere. A channel 300a is also depicted in FIG. 3. The channel 300a may be used with any embodiment of the multi-point locks described herein. The channel 300a acts to reinforce the door opening into which the MPL 300 is inserted after assembly and may either entirely or completely enclose the MPL 300. If a closed channel (a tube, for example) is used, the lock may be inserted through one end of the channel. In the depicted embodiment, the lock 300 is inserted through the open portion of the channel 300a. In certain embodiments, the channel or tube may be integral with the face plate 304.

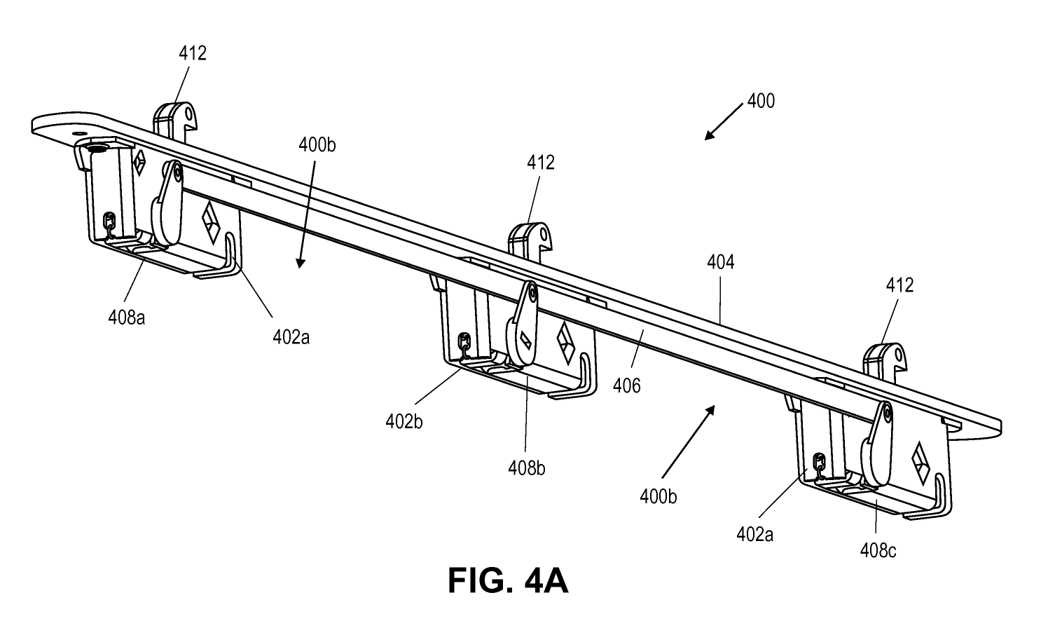

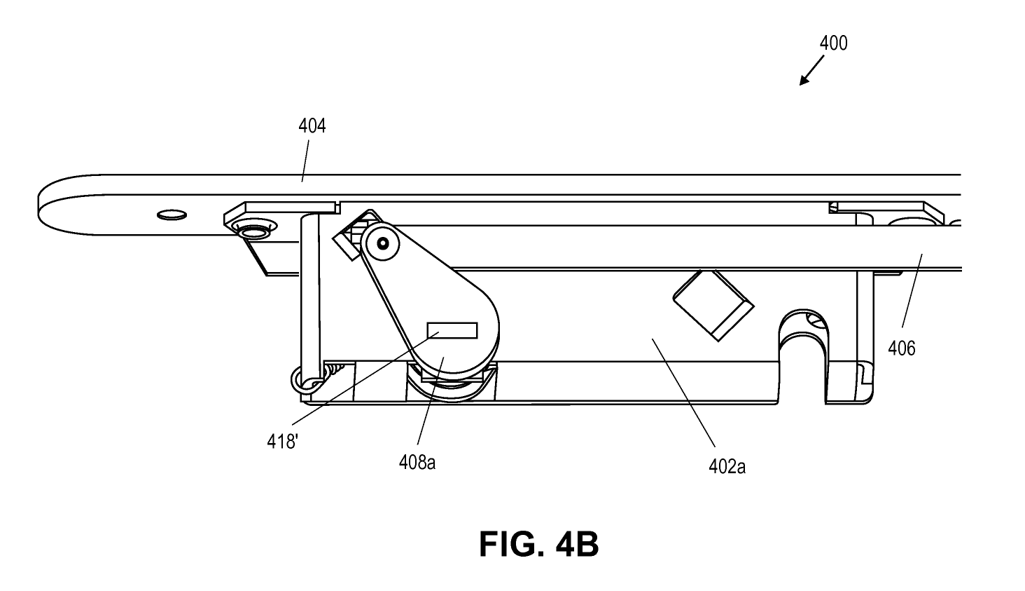

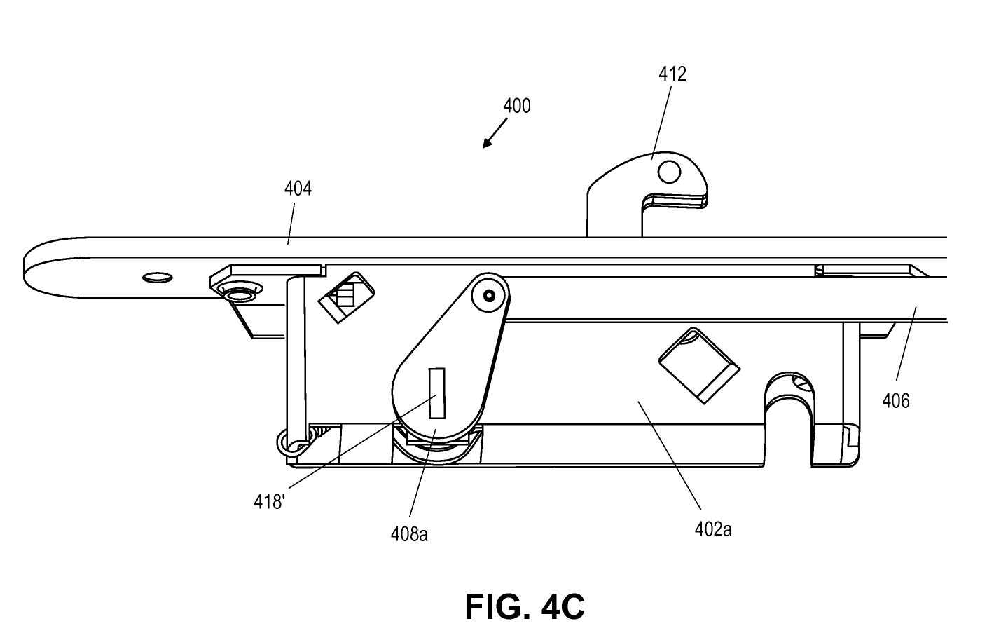

FIG. 4A depicts a side view of another MPL 400. The components and operation of the MPL 400 depicted in FIG. 4A are substantially similar to those of FIGS. 1A-1C. The MPL 400 of FIG. 4A, however, includes a third lock assembly 402c, again secured to a face plate 404, and having a locking element 412 actuated by another slave lever arm 408c. As is apparent from the disclosure, any number of lock assemblies may be utilized to form a multi-point lock utilizing the proposed technology. Four, five, or more lock assemblies may be connected to a face plate and ganged together by one or more links to produce a multi-point lock system of any desired configuration. Additionally, the lock assemblies may be configured such that the various locking elements may rotate in the same or opposite directions. Multi-point locks may be manufactured with a combination of any of the link components described and depicted above (i.e., one or more metal bars or rods, free or contained cable(s) or wire(s), etc.).

FIGS. 4B-4C depict a partial side view of the MPL 400 of FIG. 4A. In these figures, the slave lever arm 408a includes a slot 418′ similar to that of the master lever arm 408b depicted in the preceding figures. A projection or other discrete element may be inserted into the slave lever arm slot 418′ as well as the actuator slot of the second lock housing 402a. Movement of the link 406 again causes pivotal movement of the slave lever arm 408a, thereby extending the locking element 412 from the retracted position to the extended position. Additional embodiments of an MPL are contemplated. For example, the link may be configured with a number of bends such that the link may be connected to a master lever arm on a first side of an MPL, and to a slave lever arm on a second side of the MPL. The bend allows the link to pass through a gap 400b (depicted in FIG. 4A) between two adjacent lock assemblies and connect to lever arms on opposite sides of each lock assembly.

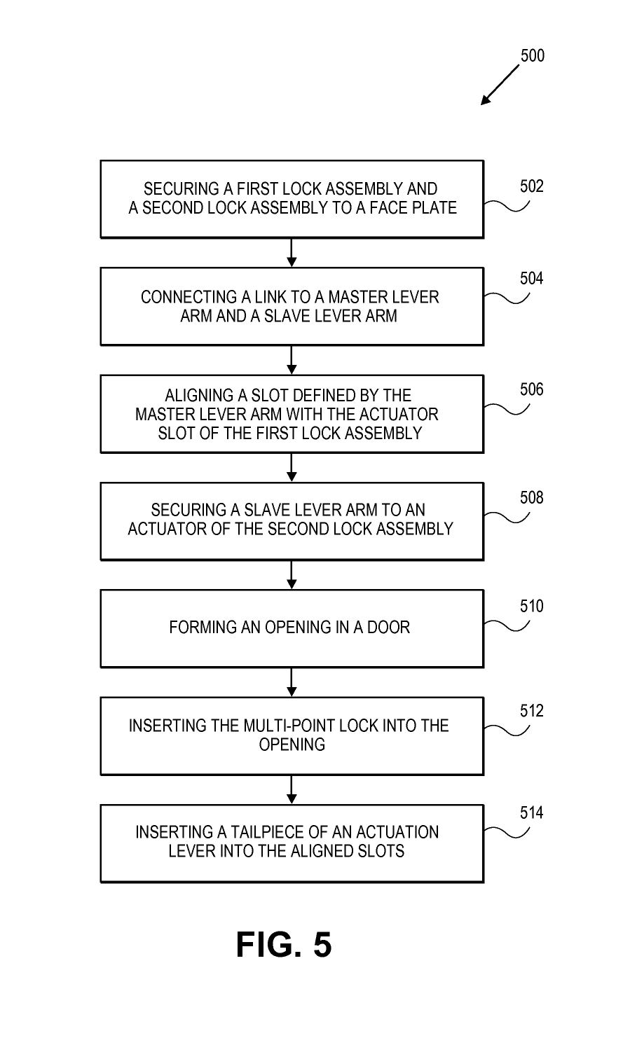

FIG. 5 depicts a method (500) of assembling an MPL that includes ganging together one or more lock assemblies. The first lock assembly and the second lock assembly may be first secured to a face plate (step 502). Thereafter, a link may be connected to both a master lever arm and a slave lever arm (step 504). A slot on the master lever arm may then be aligned with an actuator slot of the first lock assembly (step 506). A slave lever arm is secured to an actuator of the second lock assembly (step 508). Depending on the configuration of the slave lever arm, this slave arm securing step may include inserting a projection element through both the slave lever arm slot and a slot defined by the actuator of the second lock assembly. Alternatively, the slave arm securing step may include inserting a projection integral with the slave lever arm into a slot defined by the actuator of the second lock assembly. An elongate opening may be formed in an edge of a door (step 510) into which the multi-point lock is to be inserted (step 512). Once inserted, a tailpiece of an actuation lever may be inserted through the aligned master lever arm slot and the actuator slot in the first housing (step 514). Of course, the sequence of these steps may be altered as would be apparent to a person of ordinary skill in the art. Additionally, the method may be supplemented as required to accommodate incorporation of more than two lock assemblies into a multi-point lock.

The MPLs depicted herein may be sold as a kit including the components necessary to construct an MPL using two or more lock assemblies. In certain embodiments, the kit may include a master lever arm, a slave lever arm, a faceplate, a link, and any required connectors or fasteners. The link may be field configurable to allow for connection between two lever arms, regardless of the spacing of the two corresponding lock assemblies. This configurability may be achieved by breaking or cutting the link in an appropriate position. In one embodiment, the master lever arm and the slave lever arm may be identical or substantially so. If the master lever arm and slave lever arm each define a slot, a discrete projection element may be included in the kit to engage the slave lever arm with the actuator slot in the appropriate lock housing. The kit may include two or more lock assemblies, as well as an actuator lever. The actuator lever may be configured to match or otherwise complement a handle configuration that may also be included with the kit.

At least one advantage of the multi-point lock described herein is that existing lock assemblies may be ganged together to produce a multi-point lock with minimal modification of the assemblies themselves. In that regard, the additional components (lever arms, links, fasteners, etc.) may be easily assembled without modification of the lock assemblies. Readily available lock assemblies may easily be ganged together to produce a robust multi-point lock with little additional expense.

The entire multi-point lock or components thereof may be manufactured by known techniques using tooled, cast, or stamped metals typically used in the door hardware industry. Such materials may include, but are not limited to, various grades of stainless steel, zinc, brass, etc. Additionally, depending on the application and desired robustness of components, certain components may be manufactured of various injection molded plastics, including PVC, ABS, or other plastics.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A multi-point door lock comprising:
a first lock assembly and a second lock assembly, each of the first lock assembly and the second lock assembly comprising:
a housing;
an actuator defining an actuator slot; and
a locking element pivotally engaged with the housing, wherein a rotation of the actuator causes a rotation of the locking element from a retracted position to an extended position;
a master lever arm located external from the first lock assembly housing and defining a master lever arm slot aligned with the actuator slot of the first lock assembly;
a slave lever arm located external from the second lock assembly housing and engaged with the actuator slot of the second lock assembly;
a link connected to both the master lever arm and the slave lever arm and located external to both the first lock assembly housing and the second lock assembly housing; and
a face plate secured to both the first lock assembly housing and the second lock assembly housing.

2. The multi-point door lock of claim 1, further comprising an actuation lever comprising a tailpiece engaged with both the master lever arm slot and the actuator slot of the first lock assembly, wherein a rotational force applied by the actuation lever to the master lever arm causes a rotation of the slave lever arm.

3. The multi-point door lock of claim 2, wherein the tailpiece is integral with the actuation lever.

4. The multi-point door lock of claim 1, wherein the slave lever arm comprises a projection.

5. The multi-point door lock of claim 1, wherein the locking element of the first lock assembly and the locking element of the second lock assembly rotate in opposite directions.

6. The multi-point lock of claim 1, wherein the link comprises at least one of a bar drive and a cable drive.

7. The multi-point lock of claim 6, wherein the cable drive comprises at least one of a channel and a tube, and a cable adapted to move therein.

8. The multi-point lock of claim 6, wherein the cable drive comprises a first cable and a second cable, wherein the first cable is connected to a first connection on the master lever arm and the second cable is connected to a second connection on the master lever arm.

9. The multi-point lock of claim 8, wherein the first connection, the master lever arm slot, and the second connection define an alignment axis.

10. The multi-point lock of claim 6, wherein the bar drive is pivotally connected to both of the master lever arm and the slave lever arm.

11. The multi-point lock of claim 1, further comprising:
a third lock assembly comprising:
a third lock assembly housing secured to the face plate;
a third lock assembly actuator defining a third lock assembly actuator slot; and
a third lock assembly locking element pivotally engaged with the third lock assembly housing; and
a third lever arm located external from the third lock assembly housing and comprising a projection engaged with the third lock assembly actuator slot, wherein the third lever arm is connected to the link.

12. A gang kit useful in forming a multi-point lock, the gang kit comprising:
a master lever arm defining a master lever arm slot adapted to align with an actuator slot on a first lock assembly;
a slave lever arm adapted to engage with an actuator slot on a second lock assembly;
a link adapted to connect to both the master lever arm and the slave lever arm; and
a face plate adapted to be secured to both the first lock assembly and the second lock assembly.

13. The gang kit of claim 12, further comprising an actuation lever comprising a tailpiece adapted to engage with both the master lever arm slot and the actuator slot of the first lock assembly.

14. The gang kit of claim 12, further comprising the first lock assembly and the second lock assembly.

15. The gang kit of claim 12, further comprising a channel adapted to at least partially enclose the master lever arm, the slave lever arm, and the link.

16. The gang kit of claim 16, wherein the channel is integral with the face plate.

17. The gang kit of claim 12, wherein the slave link arm comprises a projection.

18. A method of ganging a first lock assembly and a second lock assembly, the method comprising:
securing the first lock assembly and the second lock assembly to a face plate;
connecting a link to a master lever arm and a slave lever arm;
aligning a slot defined by the master lever arm with an actuator slot of the first lock assembly; and
securing a slave lever arm to an actuator of the second lock assembly.

19. The method of claim 18, wherein the slave arm securing step comprises inserting a projection through both a slave lever arm slot and a slot defined by the actuator of the second lock assembly.

20. The method of claim 18, wherein the slave lever arm securing step comprises inserting a projection integral with the slave lever arm into a slot defined by the actuator of the second lock assembly.

21. The method of claim 18, further comprising inserting a tailpiece of an actuation lever through both the master lever arm slot and the actuator slot of the first lock assembly.
